(19) United States
(12) Patent Application Publication
(10) Pub. No.: US 2025/0110804 A1
(43) Pub. Date: Apr. 3, 2025

(54) DYNAMIC CONTENT FOR A TOKEN PLATFORM

(71) Applicant: Coinbase, Inc., Oakland, CA (US)

(72) Inventors: Jason Lee Thomas, Sa Francisco, CA (US); Nelson Coleman Edwards, Austin, TX (US)

(21) Appl. No.: 18/375,338

(22) Filed: Sep. 29, 2023

(51) Int. Cl. G06F 9/52; G06F 9/54

(52) U.S. Cl. CPC G06F 9/52; G06F 9/547

(57) ABSTRACT

Methods, systems, and devices for data management are described. A presentation service may receive an application programming interface (API) request to generate a first update to a content item for display at a client application. The presentation service may cause, based on receiving the API request, the first update to the content item to be displayed at the client application. The presentation service may synchronize the first update to the content item to a content management system. A service may transmit, to the content management system, a second update to the content item that is synchronized to the content management system. The presentation service may cause, based on transmitting the second update, the second update to the content item to be displayed at the client application.

### FIELD OF TECHNOLOGY

The present disclosure relates generally to data management, including techniques for dynamic content for a token platform.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIGS. 1 and 2 show examples of computing environments that support dynamic content for a token platform in accordance with aspects of the present disclosure.

FIG. 3 shows an example of a user interface diagram that supports dynamic content for a token platform in accordance with aspects of the present disclosure.

FIG. 4 shows an example of a process flow that supports dynamic content for a token platform in accordance with aspects of the present disclosure.

FIG. 5 shows a block diagram of an apparatus that supports dynamic content for a token platform in accordance with aspects of the present disclosure.

FIG. 6 shows a block diagram of a presentation service that supports dynamic content for a token platform in accordance with aspects of the present disclosure.

FIG. 7 shows a diagram of a system including a device that supports dynamic content for a token platform in accordance with aspects of the present disclosure.

FIGS. 8 and 9 show flowcharts illustrating methods that support dynamic content for a token platform in accordance with aspects of the present disclosure.

### DETAILED DESCRIPTION

Administrators of a client application may create, update, or remove content on the client application. For example, administrators of the client application, which may be a client application of a custodial token platform, may generate content for a home page or home feed of the client application. In some examples, administrators may use various, inconsistent techniques to generate and cause the display of (e.g., post) content to the home page. For example, administrators may use various content management systems, post the content via different channels, or both. In some cases, the home page of the application may not be associated with a unified mechanism to post content, update content, or both. For example, the client application may receive content (e.g., new posts), updates to content (e.g., existing content of the client application), or both according to a variety of time frames. Further, the content, updates to the content, or both may be associated with different requirements to cause the display of the content or the updates to the content. For example, the client application may display the content or the updates to the content after an update of the client application, based on refreshing the home page, or the like. As such, a unified method to generate, post, and update content on the client application may enable a consistent time frame for posting or updating content, a consistent mechanism to display new or updated content, or both.

As described herein, administrators (e.g., users of the client application) may generate and post content via a API requests, via a presentation service, via a content management service, via an artificial intelligence (AI) algorithm, or any combination thereof. The content management system may allow the administrators to select from a variety of content compatible with the client application, the home page, or both. The content management system may also enable administrators to update generated content. To publish or update content, the administrators may transmit an application programming interface (API) request to a presentation service to generate or post the content for display on the client application. The presentation service may include or access a database of stored content (or content updates) that the client application may pull from based on an attribute of a user of the client application. For example, the presentation service may include a machine learning (ML) or AI algorithm to rank, select, or both content items to display on the client application on a user device. The presentation service may rank and select the content items based on flagged content of the user, a geolocation of the user, etc. The described techniques provide a unified method to generate and post content items, updates to content items, or both on a client application. These techniques are described in further detail with respect to the figures.

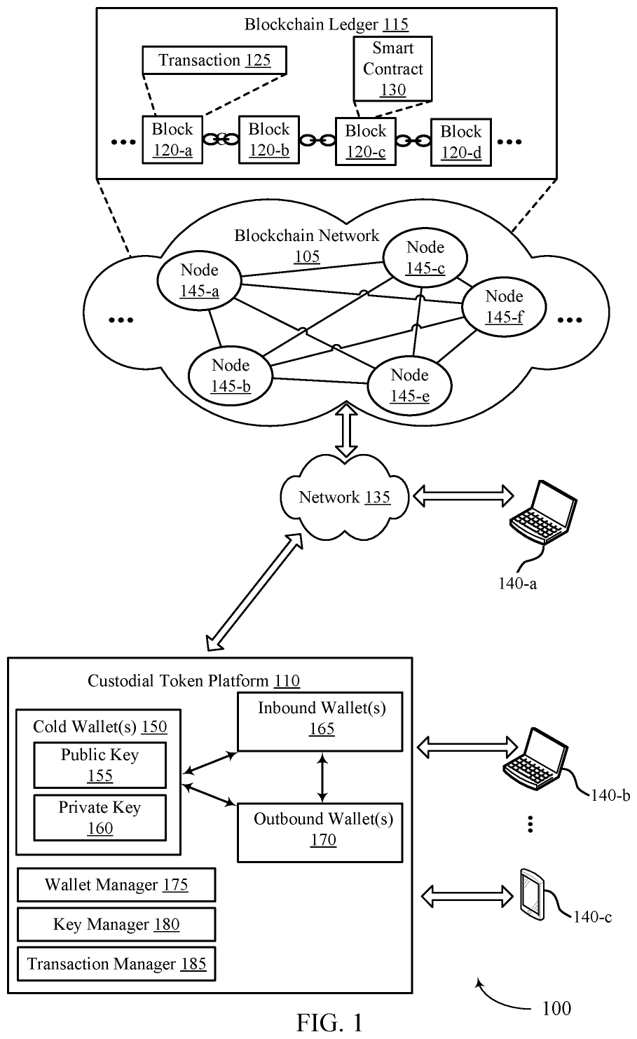

FIG. 1 illustrates an example of a computing environment 100 that supports dynamic content for a token platform in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital asset between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170) may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to cause transfer of tokens from a wallet managed by the custodial token platform 110 to an external wallet, to deploy a smart contract (e.g., a self-executing program), or to call a smart contract.

An application associated with the custodial token platform 110 on a computing device (e.g., the computing device 140-b, the computing device 140-c, etc.) may display, at a user interface of the computing device, generated or updated content for the application. For example, a presentation service associated with the application, which may be a client application, may cause the user interface of the computing device to display the generated or updated content. The presentation service may receive updates to the content via an API request, via a manual input to the presentation service, or both. For example, an administrator of the application may generate content via a content management system, which may trigger transmission of the API request to the presentation service including a first content item or an update to a first content item. The presentation service may receive the API request and synchronize the first content item or the update to the first content item with the content management system. For example, the presentation service may synchronize content or updates to content received via API requests such that the content is accessible via the content management system (e.g., for updates to the content). Additionally, or alternatively, the presentation service may receive updates to the first content item (e.g., manually). The presentation service may synchronize content items with the content management system by transmitting the updates to the content management system.

In some examples, the presentation service may select content to be displayed at a user interface based on selection criteria. For example, the presentation service may rank the content items (e.g., based on machine learning techniques), select the content items based on one or more user attributes or content types, or both. The presentation service may store the content (e.g., received via API and the content management system) and pull content to be displayed at the user interface based on the selecting.

Thus, the facilitation of generation of content and updates to content via the presentation service may support improved or reduced resource overhead. For example, as described herein, content management techniques may involve many disjointed computing systems, which may increase processor, memory, and resource overhead. In some examples, updates to content feeds may require downloading an update to the entire application, which results in increased utilization of communication bandwidth as well as processor and memory overhead at a user device. Techniques described herein address these issues by supporting streamlined and efficient content management techniques. That is, by allowing content to be generated and updated using API requests, which are then synchronized to a content management system (which may also be used to update content) the need for wholesale application updates is limited, thereby limiting processor, memory, and communication bandwidth overhead. Thus, as described herein, a content item may be updated via an API request and also via the content management system, which may support efficient and streamlined content management

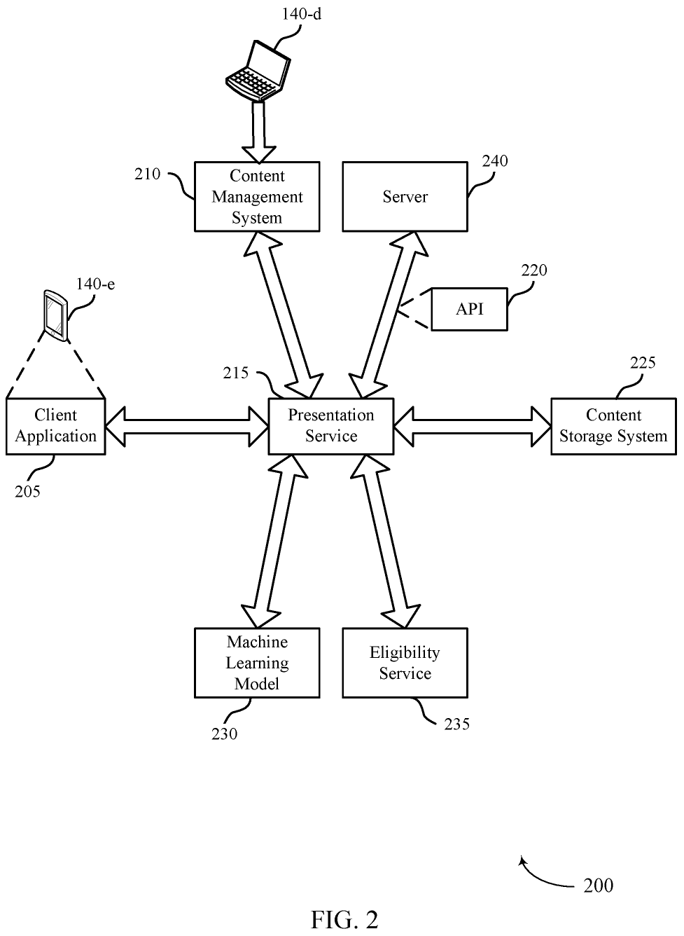

FIG. 2 shows an example of a computing environment 200 that supports dynamic content for a token platform in accordance with aspects of the present disclosure. The computing environment 200 may include a computing device 140-d and a computing device 140-e, which may be examples of corresponding devices as described with reference to FIG. 1. The computing environment 200 may also include a client application 205, which may be associated with the custodial token platform 110 as described with reference to FIG. 1.

The computing environment 200 may include the client application 205, a content management system 210, a presentation service 215, a content storage system 225, a machine learning model 230, an eligibility service 235, or any combination thereof to support dynamic content presentation for a token platform. For example, the presentation service 215 may enable content generation, content updates, or both to be displayed at the client application 205.

The presentation service 215 may receive requests to generate or update content via the content management system 210, via an API request 220, via manual entry, via an AI algorithm, or any combination thereof. In some examples, the various methods described to onboard content to the client application 205 may be associated with different advantages.

For example, the presentation service 215 may receive one or more requests to generate or update content from a server 240 via the API request 220. The server 240 may transmit the API request in response to a user configuring content at a computing device accessing or interacting with the server 240 or via another service or system interacting with the server 240.

The API request 220 may include one or more parameters associated with a generated content item, an update to a content item, or both. For example, the API request 220 may include a surface, a type, a category, or the like associated with the content item. The one or more parameters may define or indicate the content (e.g., text, image, link), the format of the content (e.g., a carousel item, a main feed item, etc.), or both.

The presentation service 215 may synchronize the generated content item, the update to the content item, or both received via the API request 220 to the content management system 210. For example, the presentation service 215 may synchronize the content item such that the user (or another authorized user) may edit the content item. Synchronization of the content item may include transmission of the content item (e.g., via an API request) to the content management system 210 and or storing the content item in the content storage system 225 from which the content management system 210 retrieves the content item.

In some examples, the presentation service 215 may receive direct (e.g., manual) updates to one or more content items. For example, after generation of the content item, a user may configure updates to the content item by accessing the presentation service 215 via the client application 205 or a backend service for management of content of the client application 205.

Additionally, or alternatively, the presentation service 215 may receive generated content items, updates to content items, or both via the content management system 210. For example, the user may publish content via the computing device 140-d to the content management system 210. In some examples, the content management system 210 may enable the user to input the one or more parameters associated with the content item (e.g., a surface, a type, a category, feature flags, etc.). In some examples, the content management system 210 may enable the user to configure a triggering condition for publishing, archiving, unpublishing, or deleting the content to the client application 205. Additionally, the user may configure or update the content via the content management system. For example, the user may access the content management system to update an image in the content, text in the content, or both.

The presentation service 215 may store the content item via the content storage system 225. For example, the presentation service 215 may store a plurality of content items via the content storage system 225 such that the plurality of content items are retrievable by the presentation service 215 to display at the client application 205. That is, the presentation service 215 may retrieve one or more content items from the content storage system 225 after selecting the one or more content items to be displayed at the client application 205. In some cases, the client application 205 may request or pull content via the presentation service 215, and the presentation service 215 may select the content for display at the client application 205 based on techniques described herein.

In some examples, the client application 205 may include a component library. When the client application receives information from the presentation service 215, the client application 205 references the component library stored on the device. The component library may include information about standard components such as cards, carousel cards, etc. The client application 205 may then display the information within the component in accordance with the ranking and format described by the presentation service 215.

In some examples, a content item may be associated with a current characteristic. For example, the content item may be associated with a crypto token having one or more attributes, such as price, that may vary over time. In such examples, the content item may be configured to obtain a current characteristic (e.g., via the component library) associated with the crypto token when pulled by the client application 205 for display via the client application 205. For example, when the presentation service 215 pulls the content item from the content storage system 225, the client application 205 may display a current characteristic of the content item. To support such techniques, the presentation service 215 or an associated system may also pull the value (e.g., price) for the characteristic for display at the user interface of the client application 205. Additionally, or alternatively, the client application 205 may periodically update the content item being displayed at the client application 205 (e.g., after initial display of the content item). That is, the client application 205 may be configured to dynamically pull the updated content or the value for the characteristic.

The presentation service 215 may select the one or more content items to be displayed at the client application 205 by using the machine learning model 230, the eligibility service 235, or both. The machine learning model 230 may rank the plurality of content items. The eligibility service 235 may manage the content items presented to a user of the client application.

In some examples, the machine learning model 230 may rank the plurality of content items based on user attributes associated with a user account of the client application 205. Additionally, or alternatively, the machine learning model 230 may produce one or more rankings of the plurality of content items for one or more user interface containers of the client application 205. For example, the machine learning model 230 may determine a first ranking for a first set of content items associated with a first container, a second ranking for a second set of content items associated with a second container, and so on. The ranking may be based on prior interaction with content items by various users. That is, the machine learning model 230 may determine that users are more likely to open content based on past metrics, based on user attributes, or both. The ranking may be a general ranking or a ranking for a particular user, or a class or segment of users.

The eligibility service 235 may select one or more content items of the plurality of content items to be displayed at the client application 205 based on a geolocation of the user, feature flags of a user account on the client application 205 associated with the user, experiments, target groups, or logic associated with the content item. For example, the content items may each be associated with (e.g., configured with) the one or more parameters (e.g., input via the API request 220, the content management system 210, or manual entry to the presentation service 215). In some examples, the eligibility service 235 may match the one or more parameters of the content item to user attributes. For example, the eligibility service 235 may select the one or more content items based on comparing the one or more parameters of each of the plurality of content items to the user attributes.

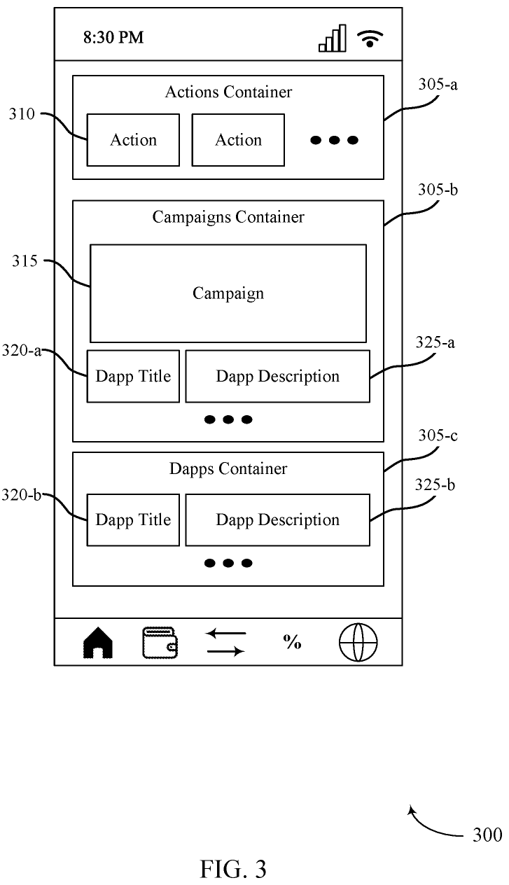

FIG. 3 shows an example of a user interface diagram 300 that supports dynamic content for a token platform in accordance with aspects of the present disclosure. The user interface diagram 300 may be implemented by a client application of a custodial token platform on a user device. For example, the user interface diagram 300 may be implemented by the client application 205 on the computing device 140-e as described with reference to FIG. 2.

A user interface diagram 300 may display a plurality of content items to support dynamic content for the token platform as described herein. The user interface diagram 300 includes an example of a user interface wherein the plurality of content items may be displayed based on generation of the plurality of content items and updates to the plurality of content items via a presentation service (e.g., the presentation service 215 as described with reference to FIG. 2), a content management system (e.g., the content management system 210 as described with reference to FIG. 2), or both.

For example, a user interface may display actions 310, campaigns 315, Dapps (e.g., information associated with Dapps), or a combination thereof within a plurality of containers. By way of example, the user interface may include an actions container 305-a, a campaigns container 305-b, a Dapps container 305-c, or a combination thereof.

In some examples, a user may define a container, such as the actions container 305-a, the campaigns container 305-b, the Dapps container 305-c, or the like. For example, the user posting or updating content items may define the container via an API request, manual entry to the presentation service, via the content management system, or a combination thereof.

Additionally, or alternatively, the user may define one or more parameters associated with the content item. For example, the user may define a set of user attributes associated with the content item, such as an interest in a crypto token, an NFT, a particular news item, or a geolocation or age of a target user. That is, the user may define the one or more parameters associated with the content item such that the content item may be ranked and displayed (e.g., by the presentation service and the client application, respectively) to users which are most likely to interact with the content item.

In some examples, the user may define a user interface component, a surface, a category, a type, or any combination thereof associated with the content item. These characteristics may be defined via interaction with the presentation service (e.g., via API requests) and/or via using the content management system. For example, a user interface component may represent an individual building block presented on a user interface, such as a card or a list. The actions container 305-a, the campaigns container 305-b, or the Dapps container 305-c may be examples of cards. The surface may represent a grouping of user interface components, such as a page or menu. For example, the user may associate the content item with a home page of the client application. The category may represent a label used to classify or segment a group of user interface components within a surface, such as different types of cards. In the example of FIG. 2, the distinctions between the actions container 305-a, the campaigns container 305-b, and the Dapps container 305-c may represent categories. The type may represent a distinct user interface component represented by a set of data fields, such as a button, card, or list. For example, the actions 310 of the actions container 305-a may be associated with a button type: the campaign 315 may be associated with a card type; and the Dapp titles 320, Dapp descriptions 325, or both may be associated with a list type.

In some examples, the user may define the one or more parameters associated with the content item such that the content item may be stored by a content storage system (such as the content storage system 225 as described with reference to FIG. 2). For example, the user may opt out of storing the content item, or opt in to storing the content item.

The actions container 305-a may include the actions 310. In some examples, the presentation service may cause the actions 310 to be displayed on the actions container 305-a in a ranked order. For example, the presentation service may determine the ranked order based on a content type associated with each action, user attributes, or both. By way of example, the presentation service may rank the actions 310 according to how recently the actions were used. Additionally, or alternatively, the presentation service may rank the actions 310 according to analytics associated with the client application. For example, the presentation service may rank the actions 310 according to interactions or impressions associated with each action. That is, actions having a greater quantity of interactions or impressions may be ranked above those with a lesser quantity of interactions or impressions.

The campaigns container 305-b may include the campaigns 315, a Dapp title 320-a, and a Dapp description 325-a (e.g., corresponding to the Dapp title 320-a). The Dapps container 305-c may include a Dapp title 320-b and a Dapp description 325-b corresponding to the Dapp title 320-b.

In some examples, the presentation service may cause the campaigns 315, the Dapps, or both to be displayed on the campaigns container 305-b and the Dapps container 305-c in a ranked order. For example, the presentation service may utilize one or more machine learning algorithms (such as the machine learning model 230 with reference to FIG. 2) to determine a ranking for content items such as the campaigns 315 or the Dapps.

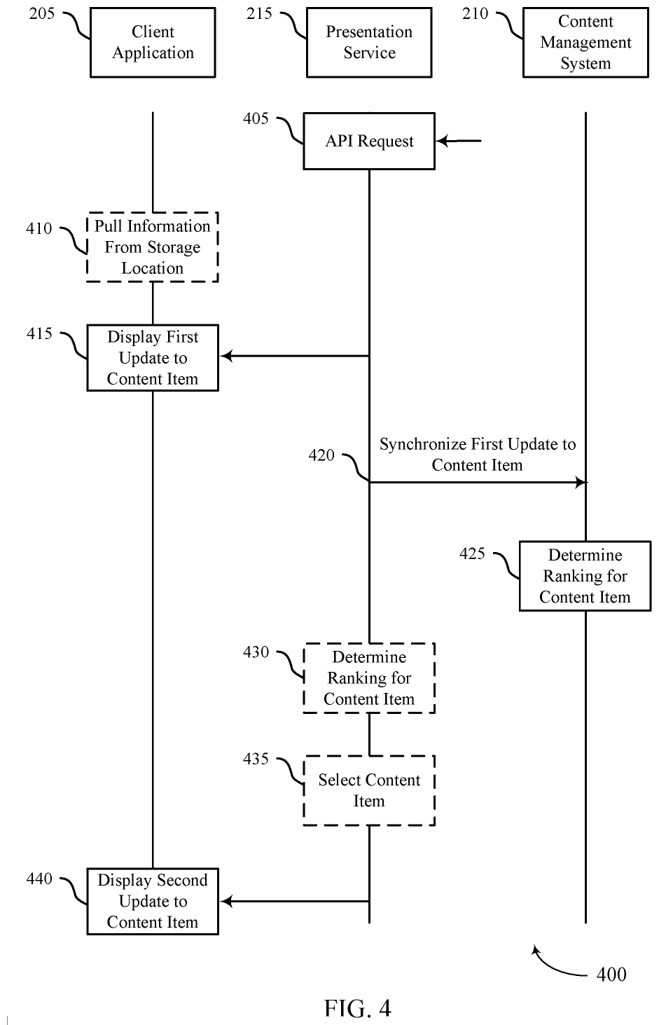

FIG. 4 shows an example of a process flow 400 that supports dynamic content for a token platform in accordance with aspects of the present disclosure. The process flow 400 may include a client application 205, a content management system 210, and a presentation service 215, which may be examples of corresponding devices as described with reference to FIG. 2.

In the following description of the process flow 400, the operations between the client application 205, the content management system 210, and the presentation service 215 may be transmitted in a different order than the example order shown, or the operations performed may be performed in different orders or at different times. Some operations may also be omitted from the process flow 400, and other operations may be added to the process flow: 400.

At 405, the presentation service 215 may receive an API request. For example, the presentation service 215 may receive the API request to generate a first update to the content item for display at the client application 205. In some examples, the API request may define a container user interface for displaying the content item. For example, the API request may define a surface or a card for displaying the content item. In some examples, a surface may represent a grouping of user interface components, such as a page or menu. Additionally, or alternatively, a user interface component may represent an individual building block presented on a user interface, such as a card or list. Additionally, or alternatively, the update may be an update to an image or text associated with the content item.

At 410, the client application 205 may pull information from a service associated with the presentation service 215. For example, the presentation service 215 may cause one or more updates to the content item (or the content item itself) to be stored in a storage location associated with the server, and the client application 205 may pull the information from the storage location based on communications with the server. The client application 205 may pull such information based on the application being opened at the user device, based on the application being refreshed, or the like. The presentation service 215 may cause the one or more updates to be stored based on receiving the API request at 405, receiving subsequent updates to the content item, or both. In some cases, after receiving an indication from the presentation service 215 that the client application 205 is to display one or more updates to the content item, the client application 205 may retrieve the one or more updates from the storage location.

At 415, the presentation service 215 may cause the first update to the content item to be displayed at the client application 205. For example, the presentation service 215 may cause the first update to the content item to be displayed at the client application 205 based on receiving the API request at 405. That is, the presentation service 215 may cause the display of one or more updates to the content item (received via the API request at 405), where the content item was selected to be displayed at the client application 205. In some examples, the client application 205 may pull information from the storage location associated with the first update to the content item and display the content item. The client application 205 may display the first content item within the container of the user interface defined by the API request at 405.

At 420, the presentation service 215 may synchronize the first update to the content item with the content management system 210. For example, the presentation service 215 may synchronize the first update to the content item with the content management system 210 such that the first update is accessible by one or more users to edit via the content management system 210. That is, the one or more users (e.g., users with a capability to post or update content) may edit or remove posts via the content management system 210.

At 425, the content management system may receive a second update to the content item. In some cases, the presentation service 215 or an associated system or service (e.g., a service of the custodial token platform) may transmit the second update to the content item that is synchronized to the content management system 210 at 430. For example, a user may manually update the content item via an interface that is used to access the content management system 210. That is, the user may access the user interface (e.g., supported by the presentation service 215 or an associated system) to post or update a content item. Additionally, or alternatively, the user may update the content item via the content management system 210 directly.

At 430, the presentation service 215 an associated system or service may determine a ranking for a set of content items including the content item. For example, the presentation service 215 may utilize machine learning models, such as the machine learning model 230 with reference to FIG. 2, to determine the ranking. In other words, the presentation service 215 may determine the ranking for the content item using one or more machine learning algorithms.

In some examples, the ranking may be associated with a user of the client application 205. For example, the one or more machine learning algorithms may output a ranking based on user attributes, user interests (e.g., interests marked via the client application 205, discovered via tracking across a user device having the client application 205, etc.), or the like. In some examples, the client application 205 may input user impressions and interactions with content into the one or more machine learning algorithms to determine the ranking.

At 435, the presentation service 215 or an associated system or service may select the content item. For example, the presentation service 215 may select the content item from a plurality of content items based on one or more selection criteria. In some examples, the one or more selection criteria may be based on a content type, such as a news item, a blog post, or the like, or based on user attributes, such as interests, a geolocation, or the like associated with a user. For example, the one or more selection criteria may be based on an eligibility service, such as the eligibility service 235 with reference to FIG. 2. In some examples, the presentation service 215 may select the content item based on the ranking determined at 430.

At 440, the presentation service 215 or an associated system or service may cause the second update to the content item to be displayed at the client application 205. For example, the client application 205 may pull information from the storage location associated with the second update to the content item and display the second update to the content item. In some examples, the client application 205 may display the second update to the content item within the container user interface defined in the API request received at 405.

In some examples, the content item may be configured to obtain a current characteristic associated with a crypto token when pulled by the client application 205 for display via the client application 205. For example, the content item may include the display of a price of a crypto token, which may vary over time, and the client application 205 may update display of the content item according to changes in the price. For example, the client application 205 may display an indication of the current characteristic.

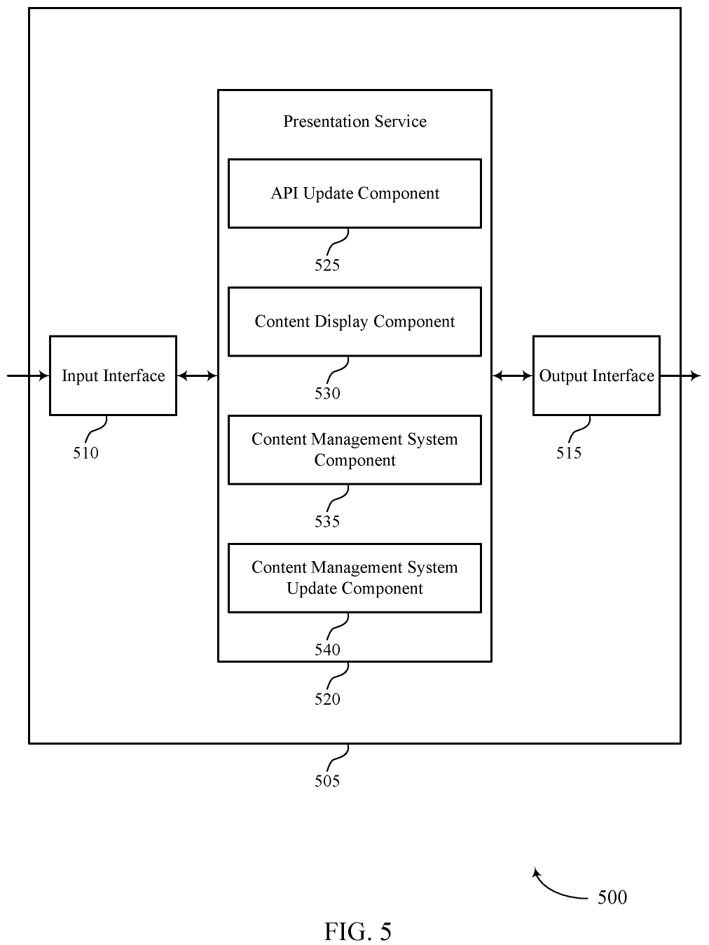

FIG. 5 shows a block diagram 500 of a system 505 that supports dynamic content for a token platform in accordance with aspects of the present disclosure. The system 505 may include an input interface 510, an output interface 515, and a presentation service 520. The system 505, or one or more components of the system 505 (e.g., the input interface 510, the output interface 515, and the presentation service 520), may include at least one processor, which may be coupled with at least one memory, to support the described techniques. Each of these components may communicate, directly or indirectly, with one another (e.g., via one or more buses, communications links, communications interfaces, or any combination thereof

The input interface 510 may manage input signaling for the system 505. For example, the input interface 510 may receive input signaling (e.g., messages, packets, data, instructions, commands, transactions, or any other form of encoded information) from other systems or devices. The input interface 510 may send signaling corresponding to (e.g., representative of or otherwise based on) such input signaling to other components of the system 505 for processing. For example, the input interface 510 may transmit such corresponding signaling to the presentation service 520 to support dynamic content for a token platform.

The output interface 515 may manage output signaling for the system 505. For example, the output interface 515 may receive signaling from other components of the system 505, such as the presentation service 520, and may transmit such output signaling corresponding to (e.g., representative of or otherwise based on) such signaling to other systems or devices.

For example, the presentation service 520 may include an API update component 525, a content display component 530, an content management system component 535, an content management system update component 540, or any combination thereof. In some examples, the presentation service 520, or various components thereof, may be configured to perform various operations (e.g., receiving, monitoring, transmitting) using or otherwise in cooperation with the input interface 510, the output interface 515, or both. For example, the presentation service 520 may receive information from the input interface 510, send information to the output interface 515, or be integrated in combination with the input interface 510, the output interface 515, or both to receive information, transmit information, or perform various other operations as described herein.

The presentation service 520 may support data management in accordance with examples as disclosed herein. The API update component 525 may be configured as or otherwise support a means for receiving an API request to generate a first update to a content item for display at a client application. The content display component 530 may be configured as or otherwise support a means for causing, based at least in part on receiving the API request, the first update to the content item to be displayed at the client application. The content management system component 535 may be configured as or otherwise support a means for synchronizing the first update to the content item to a content management system. The content management system update component 540 may be configured as or otherwise support a means for transmitting to the content management system, a second update to the content item that is synchronized to the content management system. The content display component 530 may be configured as or otherwise support a means for causing, based at least in part on transmitting the second update, the second update to the content item to be displayed at the client application.

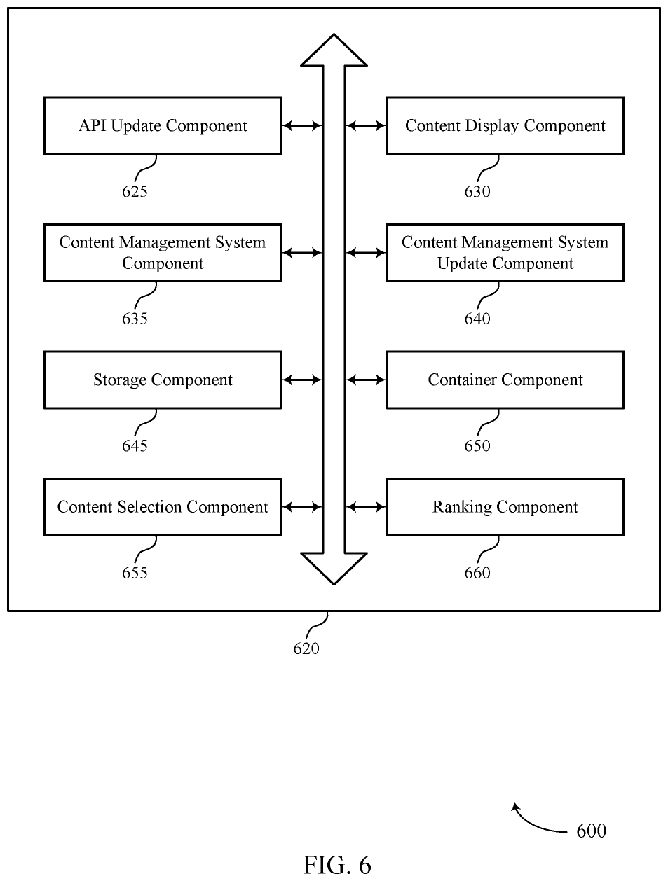

FIG. 6 shows a block diagram 600 of a presentation service 620 that supports dynamic content for a token platform in accordance with aspects of the present disclosure. The presentation service 620 may be an example of aspects of a presentation service 520 or a custodial token platform, as described herein. The presentation service 620, or various components thereof, may be an example of means for performing various aspects of dynamic content for a token platform as described herein. For example, the presentation service 620 may include an API update component 625, a content display component 630, an content management system component 635, an content management system update component 640, a storage component 645, a container component 650, a content selection component 655, a ranking component 660, or any combination thereof. Each of these components may communicate, directly or indirectly, with one another (e.g., via one or more buses, communications links, communications interfaces, or any combination thereof

The presentation service 620 may support data management in accordance with examples as disclosed herein. The API update component 625 may be configured as or otherwise support a means for receiving an API request to generate a first update to a content item for display at a client application. The content display component 630 may be configured as or otherwise support a means for causing, based at least in part on receiving the API request, the first update to the content item to be displayed at the client application. The content management system component 635 may be configured as or otherwise support a means for synchronizing the first update to the content item to a content management system. The content management system update component 640 may be configured as or otherwise support a means for transmitting to the content management system, a second update to the content item that is synchronized to the content management system. In some examples, the content display component 630 may be configured as or otherwise support a means for causing, based at least in part on transmitting the second update, the second update to the content item to be displayed at the client application.

In some examples, to support causing the first update or the second update to the content item to be displayed at the client application, the storage component 645 may be configured as or otherwise support a means for causing the first update or the second update to be stored in a storage location from which the client application pulls information.

In some examples, to support receiving the API request, the container component 650 may be configured as or otherwise support a means for receiving the API request that defines a container user interface for displaying the content item.

In some examples, to support transmitting the second update to the content item, the container component 650 may be configured as or otherwise support a means for transmitting the second update to the content item that is to be displayed within the container user interface.

In some examples, to support causing the first update or the second update to be displayed at the client application, the content selection component 655 may be configured as or otherwise support a means for selecting the content item from a plurality of content items based at least in part on one or more selection criteria.

In some examples, the one or more selection criteria are based on a content type or user attributes.

In some examples, the ranking component 660 may be configured as or otherwise support a means for determining a ranking for the content item using one or more machine learning algorithms, wherein the content item is selected based at least in part on the determined ranking for the content item.

In some examples, the content item is configured to obtain a current characteristic associated with a crypto token when pulled by the client application for display via the client application, and wherein the content item is configured to display, at the client application, an indication of the current characteristic.

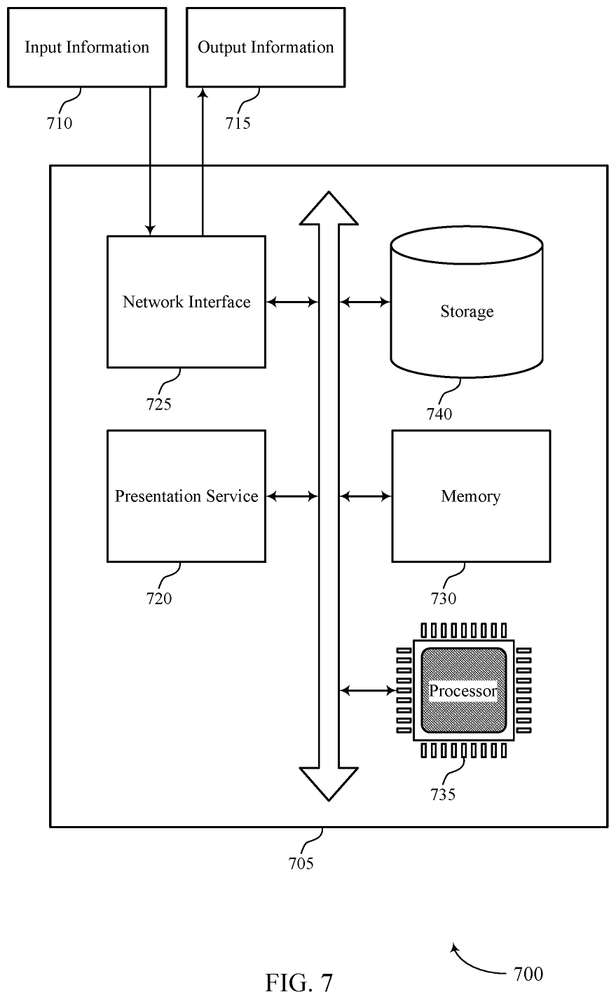

FIG. 7 shows a diagram of a system 700 including a system 705 that supports dynamic content for a token platform in accordance with aspects of the present disclosure. The system 705 may be an example of or include the components of a system 505 as described herein. The system 705 may include components for dynamic content for the token platform, such as a presentation service 720, an input information 710, an output information 715, a network interface 725, at least one memory 730, at least one processor 735, and a storage 740. Each of these components may communicate, directly or indirectly, with one another (e.g., via one or more buses, communications links, communications interfaces, or any combination thereof).

The network interface 725 may enable the system 705 to exchange information (e.g., input information 710, output information 715, or both) with other systems or devices (not shown). For example, the network interface 725 may enable the system 705 to connect to a network (e.g., a network 135 as described herein). The network interface 725 may include one or more wireless network interfaces, one or more wired network interfaces, or any combination thereof.

Memory 730 may include RAM, ROM, or both. The memory 730 may store computer-readable, computer-executable software including instructions that, when executed, cause at least one processor 735 to perform various functions described herein, such as functions supporting dynamic content for a token platform. In some cases, the memory 730 may contain, among other things, a basic input/output system (BIOS), which may control basic hardware or software operation such as the interaction with peripheral components or devices. In some cases, the memory 730 may be an example of aspects of one or more components of a custodial token platform 110 as described with reference to FIG. 1. The memory 730 may be an example of a single memory or multiple memories. For example, the system 705 may include one or more memories 730.

The processor 735 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 735 may be configured to execute computer-readable instructions stored in at least one memory 730 to perform various functions (e.g., functions or tasks supporting dynamic content for a token platform). Though a single processor 735 is depicted in the example of FIG. 7, it is to be understood that the system 705 may include any quantity of one or more of processors 735 and that a group of processors 735 may collectively perform one or more functions ascribed herein to a processor, such as the processor 735. The processor 735 may be an example of a single processor or multiple processors. For example, the system 705 may include one or more processors 735.

Storage 740 may be configured to store data that is generated, processed, stored, or otherwise used by the system 705. In some cases, the storage 740 may include one or more HDDs, one or more SDDs, or both. In some examples, the storage 740 may be an example of a single database, a distributed database, multiple distributed databases, a data store, a data lake, or an emergency backup database.

The presentation service 720 may support data management in accordance with examples as disclosed herein. For example, the presentation service 720 may be configured as or otherwise support a means for receiving an API request to generate a first update to a content item for display at a client application. The presentation service 720 may be configured as or otherwise support a means for causing, based at least in part on receiving the API request, the first update to the content item to be displayed at the client application. The presentation service 720 may be configured as or otherwise support a means for synchronizing the first update to the content item to a content management system. The presentation service 720 may be configured as or otherwise support a means for transmitting to the content management system, a second update to the content item that is synchronized to the content management system. The presentation service 720 may be configured as or otherwise support a means for causing, based at least in part on transmitting the second update, the second update to the content item to be displayed at the client application.

By including or configuring the presentation service 720 in accordance with examples as described herein, the system 705 may support techniques for improved user experience.

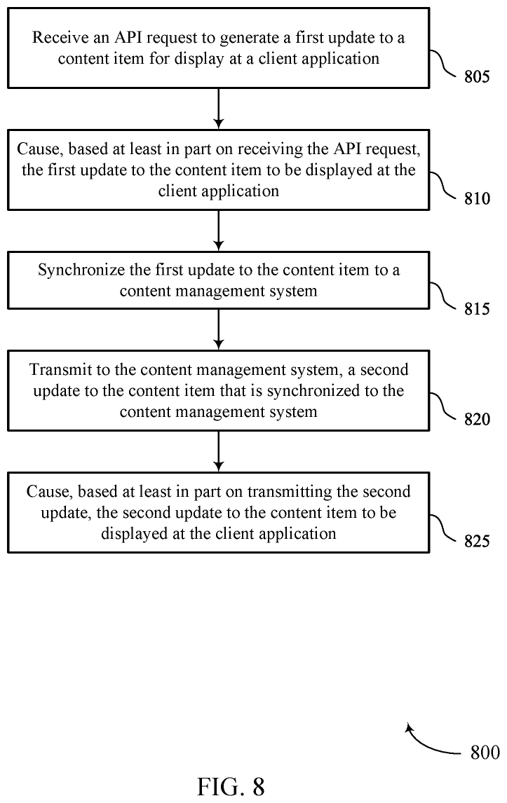

FIG. 8 shows a flowchart illustrating a method 800 that supports dynamic content for a token platform in accordance with aspects of the present disclosure. The operations of the method 800 may be implemented by a presentation service or its components as described herein. For example, the operations of the method 800 may be performed by a presentation service as described with reference to FIGS. 1 through 7. In some examples, a presentation service may execute a set of instructions to control the functional elements of the presentation service to perform the described functions. Additionally, or alternatively, the presentation service may perform aspects of the described functions using special-purpose hardware.

At 805, the method may include receiving an API request to generate a first update to a content item for display at a client application. The operations of block 805 may be performed in accordance with examples as disclosed herein. In some examples, aspects of the operations of 805 may be performed by an API update component 625 as described with reference to FIG. 6.

At 810, the method may include causing, based at least in part on receiving the API request, the first update to the content item to be displayed at the client application. The operations of block 810 may be performed in accordance with examples as disclosed herein. In some examples, aspects of the operations of 810 may be performed by a content display component 630 as described with reference to FIG. 6.

At 815, the method may include synchronizing the first update to the content item to a content management system. The operations of block 815 may be performed in accordance with examples as disclosed herein. In some examples, aspects of the operations of 815 may be performed by an content management system component 635 as described with reference to FIG. 6.

At 820, the method may include transmitting to the content management system, a second update to the content item that is synchronized to the content management system. The operations of block 820 may be performed in accordance with examples as disclosed herein. In some examples, aspects of the operations of 820 may be performed by an content management system update component 640 as described with reference to FIG. 6.

At 825, the method may include causing, based at least in part on transmitting the second update, the second update to the content item to be displayed at the client application. The operations of block 825 may be performed in accordance with examples as disclosed herein. In some examples, aspects of the operations of 825 may be performed by a content display component 630 as described with reference to FIG. 6.

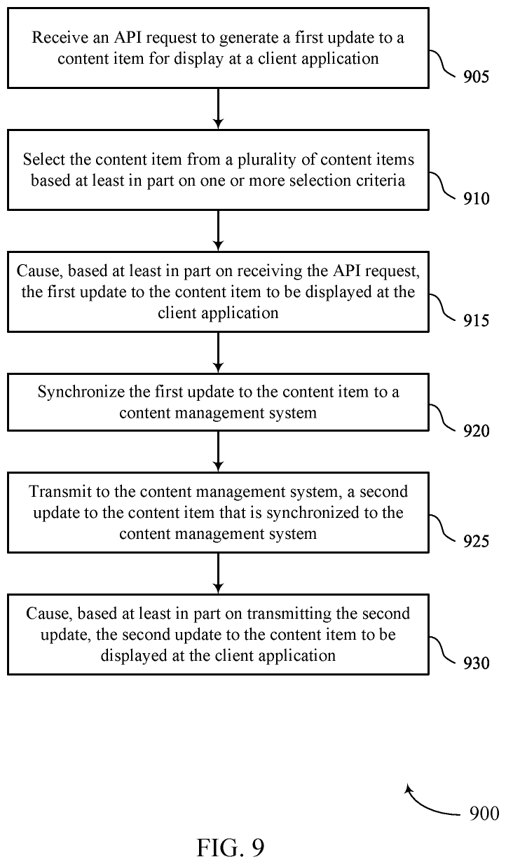

FIG. 9 shows a flowchart illustrating a method 900 that supports dynamic content for a token platform in accordance with aspects of the present disclosure. The operations of the method 900 may be implemented by a presentation service or its components as described herein. For example, the operations of the method 900 may be performed by a presentation service as described with reference to FIGS. 1 through 7. In some examples, a presentation service may execute a set of instructions to control the functional elements of the presentation service to perform the described functions. Additionally, or alternatively, the presentation service may perform aspects of the described functions using special-purpose hardware.

At 905, the method may include receiving an API request to generate a first update to a content item for display at a client application. The operations of block 905 may be performed in accordance with examples as disclosed herein. In some examples, aspects of the operations of 905 may be performed by an API update component 625 as described with reference to FIG. 6.

At 910, the method may include selecting the content item from a plurality of content items based at least in part on one or more selection criteria. The operations of block 910 may be performed in accordance with examples as disclosed herein. In some examples, aspects of the operations of 910 may be performed by a content selection component 655 as described with reference to FIG. 6.

At 915, the method may include causing, based at least in part on receiving the API request, the first update to the content item to be displayed at the client application. The operations of block 915 may be performed in accordance with examples as disclosed herein. In some examples, aspects of the operations of 915 may be performed by a content display component 630 as described with reference to FIG. 6.

At 920, the method may include synchronizing the first update to the content item to a content management system. The operations of block 920 may be performed in accordance with examples as disclosed herein. In some examples, aspects of the operations of 920 may be performed by an content management system component 635 as described with reference to FIG. 6.

At 925, the method may include transmitting to the content management system, a second update to the content item that is synchronized to the content management system. The operations of block 925 may be performed in accordance with examples as disclosed herein. In some examples, aspects of the operations of 925 may be performed by an content management system update component 640 as described with reference to FIG. 6.

At 930, the method may include causing, based at least in part on transmitting the second update, the second update to the content item to be displayed at the client application. The operations of block 930 may be performed in accordance with examples as disclosed herein. In some examples, aspects of the operations of 930 may be performed by a content display component 630 as described with reference to FIG. 6.

A method for data management by an apparatus is described. The method may include receiving an API request to generate a first update to a content item for display at a client application, causing, based at least in part on receiving the API request, the first update to the content item to be displayed at the client application, synchronizing the first update to the content item to a content management system, transmitting to the content management system, a second update to the content item that is synchronized to the content management system, and causing, based at least in part on transmitting the second update, the second update to the content item to be displayed at the client application.

An apparatus for data management is described. The apparatus may include one or more memories storing processor executable code, and one or more processors coupled with the one or more memories. The one or more processors may individually or collectively operable to execute the code to cause the apparatus to receive an API request to generate a first update to a content item for display at a client application, cause, based at least in part on receiving the API request, the first update to the content item to be displayed at the client application, synchronize the first update to the content item to a content management system, transmit to the content management system, a second update to the content item that is synchronized to the content management system, and cause, based at least in part on transmitting the second update, the second update to the content item to be displayed at the client application.

Another apparatus for data management is described. The apparatus may include means for receiving an API request to generate a first update to a content item for display at a client application, means for causing, based at least in part on receiving the API request, the first update to the content item to be displayed at the client application, means for synchronizing the first update to the content item to a content management system, means for transmitting to the content management system, a second update to the content item that is synchronized to the content management system, and means for causing, based at least in part on transmitting the second update, the second update to the content item to be displayed at the client application.

A non-transitory computer-readable medium storing code for data management is described. The code may include instructions executable by a processor to receive an API request to generate a first update to a content item for display at a client application, cause, based at least in part on receiving the API request, the first update to the content item to be displayed at the client application, synchronize the first update to the content item to a content management system, transmit to the content management system, a second update to the content item that is synchronized to the content management system, and cause, based at least in part on transmitting the second update, the second update to the content item to be displayed at the client application.

In some examples of the method, apparatus, and non-transitory computer-readable medium described herein, causing the first update or the second update to the content item to be displayed at the client application may include operations, features, means, or instructions for causing the first update or the second update to be stored in a storage location from which the client application pulls information.

In some examples of the method, apparatus, and non-transitory computer-readable medium described herein, receiving the API request may include operations, features, means, or instructions for receiving the API request that defines a container user interface for displaying the content item.

In some examples of the method, apparatus, and non-transitory computer-readable medium described herein, transmitting the second update to the content item may include operations, features, means, or instructions for transmitting the second update to the content item that may be displayed within the container user interface.

In some examples of the method, apparatus, and non-transitory computer-readable medium described herein, causing the first update or the second update to be displayed at the client application may include operations, features, means, or instructions for selecting the content item from a plurality of content items based at least in part on one or more selection criteria.

In some examples of the method, apparatus, and non-transitory computer-readable medium described herein, the one or more selection criteria may be based on a content type or user attributes.

Some examples of the method, apparatus, and non-transitory computer-readable medium described herein may further include operations, features, means, or instructions for determining a ranking for the content item using one or more machine learning algorithms, wherein the content item may be selected based at least in part on the determined ranking for the content item.

In some examples of the method, apparatus, and non-transitory computer-readable medium described herein, the content item may be configured to obtain a current characteristic associated with a crypto token when pulled by the client application for display via the client application, and wherein the content item may be configured to display, at the client application, an indication of the current characteristic.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary.” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a.” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for data management, comprising:
receiving an application programming interface (API) request to generate a first update to a content item for display at a client application:
causing, based at least in part on receiving the API request, the first update to the content item to be displayed at the client application:
synchronizing the first update to the content item to a content management system:
transmitting to the content management system, a second update to the content item that is synchronized to the content management system; and
causing, based at least in part on transmitting the second update, the second update to the content item to be displayed at the client application.

2. The method of claim 1, wherein causing the first update or the second update to the content item to be displayed at the client application comprises:
causing the first update or the second update to be stored in a storage location from which the client application pulls information.

3. The method of claim 1, wherein receiving the API request comprises:
receiving the API request that defines a container user interface for displaying the content item.

4. The method of claim 3, wherein transmitting the second update to the content item comprises:
transmitting the second update to the content item that is to be displayed within the container user interface.

5. The method of claim 1, wherein causing the first update or the second update to be displayed at the client application comprises:
selecting the content item from a plurality of content items based at least in part on one or more selection criteria.

6. The method of claim 5, wherein the one or more selection criteria are based on a content type or user attributes.

7. The method of claim 5, further comprising:
determining a ranking for the content item using one or more machine learning algorithms, wherein the content item is selected based at least in part on the determined ranking for the content item.

8. The method of claim 1, wherein the content item is configured to obtain a current characteristic associated with a crypto token when pulled by the client application for display via the client application, and wherein the content item is configured to display, at the client application, an indication of the current characteristic.

9. An apparatus for data management, comprising:
one or more memories storing processor-executable code; and
one or more processors coupled with the one or more memories and individually or collectively operable to execute the code to cause the apparatus to:
receive an application programming interface (API) request to generate a first update to a content item for display at a client application;
cause, based at least in part on receiving the API request, the first update to the content item to be displayed at the client application:
synchronize the first update to the content item to a content management system:
transmit to the content management system, a second update to the content item that is synchronized to the content management system; and
cause, based at least in part on transmitting the second update, the second update to the content item to be displayed at the client application.

10. The apparatus of claim 9, wherein, to cause the first update or the second update to the content item to be displayed at the client application, the one or more processors are individually or collectively operable to execute the code to cause the apparatus to:
cause the first update or the second update to be stored in a storage location from which the client application pulls information.

11. The apparatus of claim 9, wherein, to receive the API request, the one or more processors are individually or collectively operable to execute the code to cause the apparatus to:
receive the API request that defines a container user interface for displaying the content item.

12. The apparatus of claim 11, wherein, to transmit the second update to the content item, the one or more processors are individually or collectively operable to execute the code to cause the apparatus to:
transmit the second update to the content item that is to be displayed within the container user interface.

13. The apparatus of claim 9, wherein, to cause the first update or the second update to be displayed at the client application, the one or more processors are individually or collectively operable to execute the code to cause the apparatus to:
select the content item from a plurality of content items based at least in part on one or more selection criteria.

14. The apparatus of claim 13, wherein the one or more selection criteria are based on a content type or user attributes.

15. The apparatus of claim 13, wherein the one or more processors are individually or collectively further operable to execute the code to cause the apparatus to:
determine a ranking for the content item using one or more machine learning algorithms, wherein the content item is selected based at least in part on the determined ranking for the content item.

16. The apparatus of claim 9, wherein the content item is configured to obtain a current characteristic associated with a crypto token when pulled by the client application for display via the client application, and wherein the content item is configured to display, at the client application, an indication of the current characteristic.

17. A non-transitory computer-readable medium storing code for data management, the code comprising instructions executable by one or more processors to:
receive an application programming interface (API) request to generate a first update to a content item for display at a client application:
cause, based at least in part on receiving the API request, the first update to the content item to be displayed at the client application:
synchronize the first update to the content item to a content management system;
transmit to the content management system, a second update to the content item that is synchronized to the content management system; and
cause, based at least in part on transmitting the second update, the second update to the content item to be displayed at the client application.

18. The non-transitory computer-readable medium of claim 17, wherein the instructions to cause the first update or the second update to the content item to be displayed at the client application are executable by the one or more processors to:
cause the first update or the second update to be stored in a storage location from which the client application pulls information.

19. The non-transitory computer-readable medium of claim 17, wherein the instructions to receive the API request are executable by the one or more processors to:
receive the API request that defines a container user interface for displaying the content item.

20. The non-transitory computer-readable medium of claim 19, wherein the instructions to transmit the second update to the content item are executable by the one or more processors to:
transmit the second update to the content item that is to be displayed within the container user interface.
